(19) United States
(12) Patent Application Publication
(10) Pub. No.: US 2006/0221371 A1
(43) Pub. Date: Oct. 5, 2006

(54) Image forming device, image processing device, image processing method, and computer readable recording medium stored with image processing program

(75) Inventor: Kenji Ogasawara, Toda-Shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/377,436

(22) Filed: Mar. 17, 2006

(30) Foreign Application Priority Data
Mar. 31, 2005 (JP) 2005-104681
Oct. 25, 2005 (JP) 2005-310527

(51) Int. Cl. G06F 3/12

(52) U.S. Cl. 358/1.13; 358/448

(57) ABSTRACT

Disclosed is an image processing device which comprises: a plurality of color component image processing units; and an image forming unit. The plurality of color component image processing units are respectively provided for a plurality of color components and are operable in parallel with each other, wherein each color component image processing unit is for applying image processing to first image data and second image data contained in page data for the respective color component and is for combining the processed first image data and the processed second image data of the respective color component, in response to the completion of the image processing for the respective color component. The image forming unit forms an image based on image data for the plurality of color components processed by the plurality of color component image processing units.

### CROSS-REFERENCE TO RELATED APPLICATIONS

This application is based on Japanese Patent Applications No. 2005-104681 filed on Mar. 31, 2005 and No. 2005-310527 filed on Oct. 25, 2005, the contents of which are hereby relied on to correct possible errors in the present application.

### BACKGROUND OF THE INVENTION

1. Field of the Invention

The present invention relates to an image forming device, an image processing device, an image processing method, and a computer readable recording medium stored with an image processing program. The present invention relates specifically to an image forming device, an image processing device, an image processing method, and a computer readable recording medium stored with an image processing program for processing page data consisting of variable data and fixed data for each one of a plurality of color components.

2. Description of the Related Art

A printing method called “variable print” has been developed in recent years for the purpose of mass printing typified by direct mail from the viewpoint of CRM (Customer Relationship Management) as taught in Unexamined Japanese Patent Publication No. JP-A-2003-296070. Variable print here means a printing method in which the output contents of each page can be partially changed depending on one's preferences. The page data for the variable print is synthesized by combining variable data with fixed data that is used commonly for a plurality of pages throughout a file. Meanwhile, offset printing is not suitable for variable print as it is a mass printing method based on certain fixed data.

Also, in executing variable print with a color printer there is a practical problem that it takes a lot of processing time in order to do mass printing due to substantial time required for rasterizing process (RIP: Raster Image Processing) for converting PDL files described in a Page Descriptive Language (PDL) such as the PCL (Printer Control Language) into bitmap format image data (raster data) for mass printing.

In order to solve this problem, in Unexamined Japanese Patent Publication No. JP-A-2004-050606, a printing device is disclosed in which each color component of color page data is processed in parallel. The time required for the rasterizing process is shortened thanks to the parallel processing in this printing device.

On the other hand, the printing device described in the aforementioned Unexamined Japanese Patent Publication No. JP-A-2004-050506 gave no consideration to the process for combining the variable data and the fixed data, which is essential for the execution of variable print. However, it is important how to execute the synthesizing process for combining the variable data and the fixed data required for each color component as well as the rasterizing process required for each color component as it affects the total time required for printing through the variable print. However, the printing device described in the Unexamined Japanese Patent Publication No. JP-A-2004-050606 does not disclose technology for shortening the processing time for preparing page data for printing, especially the time for the synthesizing process.

### OBJECTS AND SUMMARY

It is an object of the present invention to provide an image forming device, an image processing device, an image processing method, and a computer readable storage medium storing an image processing program, which are improved for solving the abovementioned problems.

It is another object of the present invention to provide an image forming device, an image processing device, an image processing method, and a computer readable recording medium storing an image processing program capable of increasing the speed of processing page data consisting of variable data and fixed data for each one of a plurality of color components.

According to an embodiment of the invention, there is provided an image forming device comprising: a plurality of color component image processing units respectively provided for a plurality of color components and being operable in parallel with each other, each color component image processing unit being for applying image processing to first image data and second image data contained in page data for the respective color component and being for combining the processed first image data and the processed second image data of the respective color component, in response to the completion of the image processing for the respective color component; and an image forming unit for forming an image based on image data for the plurality of color components processed by the color component image processing units.

According to another embodiment of the invention, there is provided an image processing device comprising: an image processing unit that applies image processing to page data containing for each of a plurality of color components first image data and second image data, the image processing for one of the color components being applied in parallel with the image processing for remaining one(s) of the color components; and a synthesizing unit that combines, for each color components, the processed first image data and the processed second image data, in response to the completion of the image processing to the first image data for the respective color component.

According to still another embodiment of the invention, there is provided an image processing method comprising the steps of: 1) applying image processing to page data containing for each of a plurality of color components first image data and second image data, the image processing for one of the color components being applied in parallel with the image processing for remaining one(s) of the color components; and 2) combining, for each color component, the processed first image data and the processed second image data, in response to the completion of the image processing of the first image data for the respective color component.

According to a further embodiment of the invention, there is provided a computer readable recording medium stored with an image processing program, said image processing program causing a computer to execute a process comprising the steps of: 1) applying image processing to page data containing for each of a plurality of color components first image data and second image data, the image processing for one of the color components being applied in parallel with the image processing for remaining one(s) of the color components; and 2) combining, for each color component, the processed first image data and the processed second image data, in response to the completion of the image processing to the first image data for the respective color component.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is an overall block diagram of the image processing system according to a first embodiment of the invention.

FIG. 2 is a block diagram showing general constitution of a printer controller.

FIG. 3 is a diagram for describing a page queue, a raster C queue, a raster M queue, a raster Y queue and a raster K queue.

FIG. 4 is a block diagram showing constitution of a RIP and synthesizing unit.

FIG. 5 is a diagram for describing rasterizers, RIP-C, RIP-M, RIP-Y, and RIP-K.

FIG. 6 is a diagram for describing a variable data storage unit and a variable raster data storage unit.

FIG. 7 is a diagram for describing a form data storage unit, a form raster data storage unit, and a variable raster data storage unit.

FIG. 8 is a diagram exemplifying data handled by the present embodiment.

FIG. 9 is a flowchart showing a sequence of steps taken by the main processor of the printer controller.

FIG. 10 is a flowchart showing a sequence of steps in printing job receiving process.

FIG. 11 is a flowchart showing a sequence of steps in printing page data receiving process.

FIG. 12 is a flowchart showing a sequence of steps taken by a sub processor for processing variable data of the printer controller.

FIG. 13 is a flowchart showing a sequence of steps taken by a sub processor for processing form data of the printer controller.

FIG. 14 is a flowchart showing a sequence of steps taken by the sub processor for processing form data of the printer controller, continued from FIG. 13.

FIG. 15 is a time chart for the printing process of page data contained in a printing job according to the present embodiment.

FIG. 16 is a time chart for the printing process of page data contained in a printing job according to a comparative example.

FIG. 17 is a diagram for describing a masking process.

### DETAILED DESCRIPTION OF PREFERED EMBODIMENTS

The embodiments of this invention will be described below with reference to the accompanying drawings.

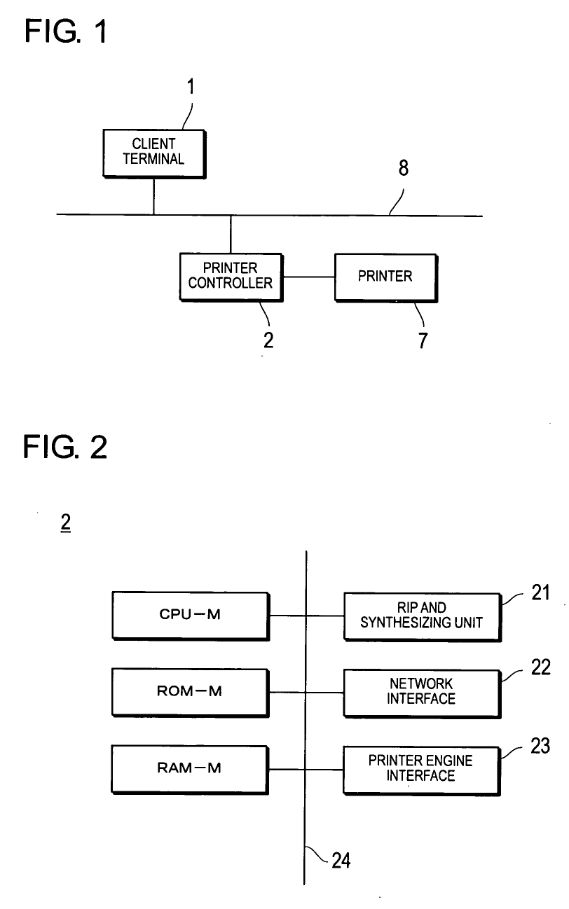

FIG. 1 is an overall block diagram of the image processing system according to a first embodiment of the invention.

The image processing system is equipped with a client terminal 1, a printer controller 2, and a printer 7.

The client terminal 1 and the printer controller 2 are communicably connected with each other via a network 8. The network 8 can be a LAN connecting computers and network equipment according to standards such as Ethernet®, Token Ring, and FDDI, or a WAN that consists of several LANs connected by a dedicated line. The printer controller 2 and the printer 7 are connected via a dedicated interfacing bus, for example, IEEE 1394 serial bus. However, the print controller 2 and the printer 7 can be connected via the network 8 as well. The types and the number of equipments to be connected to the network 8 are not limited to those shown in FIG. 1.

The client terminal 1 creates a file in such a format as PDF (Portable Document Format) that contains variable data and form data for each one of a plurality of color components and transmits it to the printer controller 2. The variable data is replaceable data and it is defined in a file containing objects that form a portion or the entirety of a specific page, and the form data is data (fixed data) defined in the particular file and used commonly on a plurality of pages included in the particular file. The printer controller 2 applies RIP to both the variable data and the form data according to the received printing job, combines those data after RIP, and transmits the synthesized and RIP-processed page data for printing to the printer 7. The printer 7 executes the printing process of the received page data for printing.

FIG. 2 is a block diagram showing general constitution of the printer controller 2.

The printer controller 2 is equipped with CPU-M, which is the main processor; ROM-M, which is the main ROM; RAM-M, which is the main RAM; a RIP and synthesizing unit 21; a network interface 22; and a printer engine interface 23, all of which are interconnected via a bus 24 in order to exchange signals.

The CPU-M controls various parts indicated above and executes various arithmetic processes according to a program. The ROM-M stores various programs and data in advance. The RAM-M stores programs and data temporarily as a working area.

The RIP and synthesizing unit 21 applies RIP to both the variable data and the form data contained in the printing job received from the client terminal 1, and combines those data after RIP.

The network interface 22 is typically a LAN card and is used for communicating with external equipment via a network 8. The printer engine interface 23 is an interface for communicating with the printer 7.

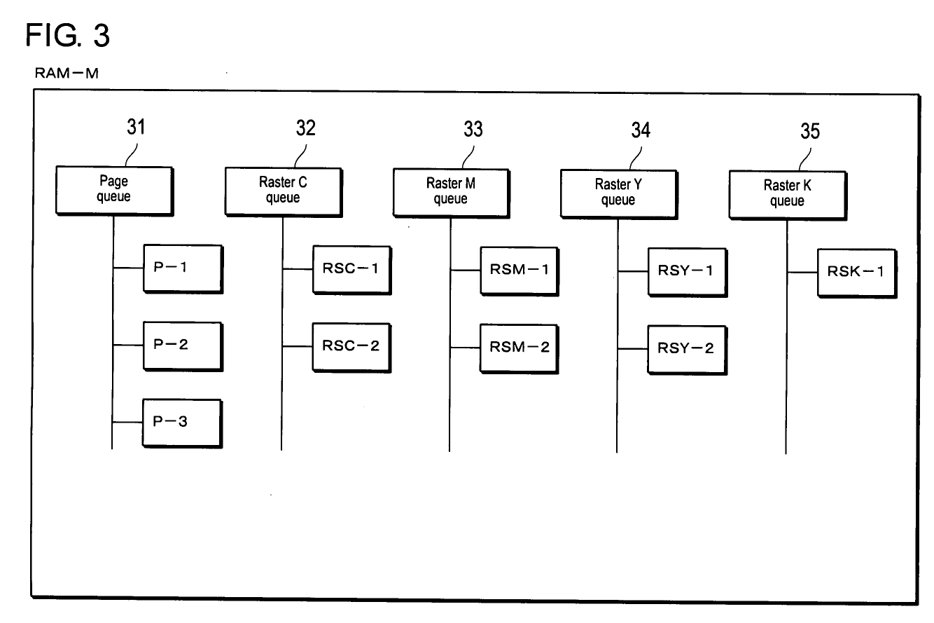

As shown in FIG. 3, the RAM-M has specific regions for a page queue 31, a raster C queue 32, a raster M queue 33, a raster Y queue 34, and a raster K queue 35 respectively. The page data of the printing job prior to the application of RIP is queued per page to the page queue 31. The page data to be queued are given ID information such as P-1, P-2, . . . in the order of pages. The page data for printing, which consists of the RIP-processed raster data of each one of the plurality of color components, i.e., C (cyan), M (magenta), Y (yellow), and K (black), is queued per each plane to the raster C queue 32, the raster M queue 33, the raster Y queue 34, and the raster K queue 35 respectively. The ID information that corresponds to the page data prior to the RIP application is attached to the page data for printing after the RIP process. For example, the raster C queue 32, the raster M queue 33, the raster Y queue 34, and the raster K queue 35 are controlled under ID information RSC-1, RSC-2, . . . ; RSM-1, RSM-2, . . . ; RSY-1, RSY-2, . . . ; and RSK-1, RSK-2, . . . , respectively.

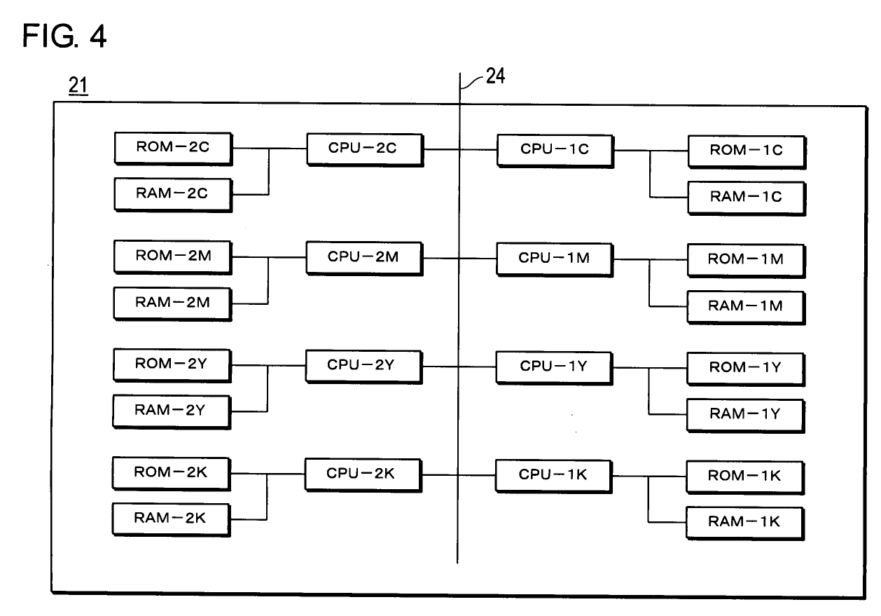

FIG. 4 is a block diagram showing the constitution of the RIP and synthesizing unit 21.

The constitution of the RIP and synthesizing unit 21 includes eight sub processors. Specifically, the constitution of the RIP and synthesizing unit 21 includes sub processors CPU-1C, CPU-1M, CPU-1Y, and CPU-1K that are sub processors for processing the form data, and sub processors CPU-2C, CPU-2M, CPU-2Y, and CPU-2K that are sub processors for processing the variable data. Here, the CPU-1C and the CPU-2C executes the processes concerning C (cyan), the CPU-1M and the CPU-2M executes the processes concerning M (magenta), the CPU-1Y and the CPU-2Y executes the processes concerning Y (yellow), and the CPU-1K and the CPU-2K executes the processes concerning K (black).

Although CPU-M, CPU-1C, CPU-1M, Cpu-1Y, and CPU-1K are preferably mounted on a single chip to constitute a multi-processor structure, each of them can also be formed as a single processor having an independent chip.

ROM-1, which is a sub ROM, and RAM-1C, which is a sub RAM, are connected to CPU-1C, which is a sub processor. Also, as indicated in the diagram, sub ROMs and sub RAMs are connected to other sub processors. The sub ROMs and sub RAMs are given the ID information that corresponds to the sub processors to which they are to be connected.

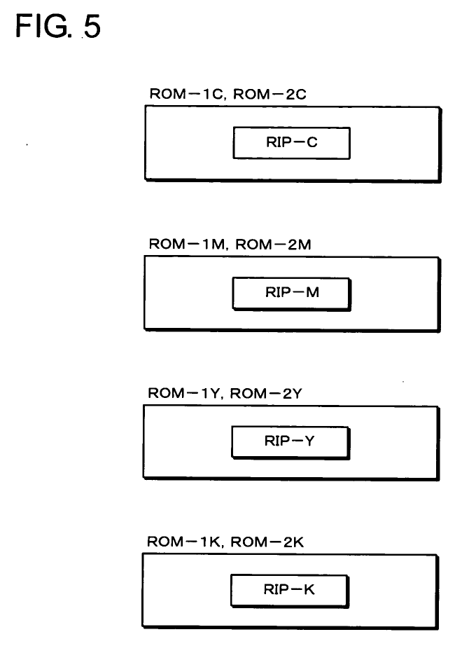

As shown in FIG. 5, ROM-1C and ROM-2C contain RIP-C, which is a rasterizer optimized for applying RIP to the page data contained in the printing job and outputting only the C (cyan) plane among a plurality of color components. Similarly, ROM-1M and ROM-2M contain RIP-M, which is a rasterizer for the M (magenta) plane, ROM-1Y and ROM-2Y contain RIP-Y, which is a rasterizer for the Y (yellow) plane, and ROM-1K and ROM-2K contain RIP-K, which is a rasterizer for the K (black) plane.

For example, in rasterizing the page data, RIP-C executes only the processes related to C (cyan) to output only the C (cyan) plane, and omits any process related to M (magenta), Y (yellow), and K (black). This makes it possible to complete output of one plane theoretically in one quarter of the time required for the conventional RIP that outputs all four planes of CMYK, although it depends on the level of optimization.

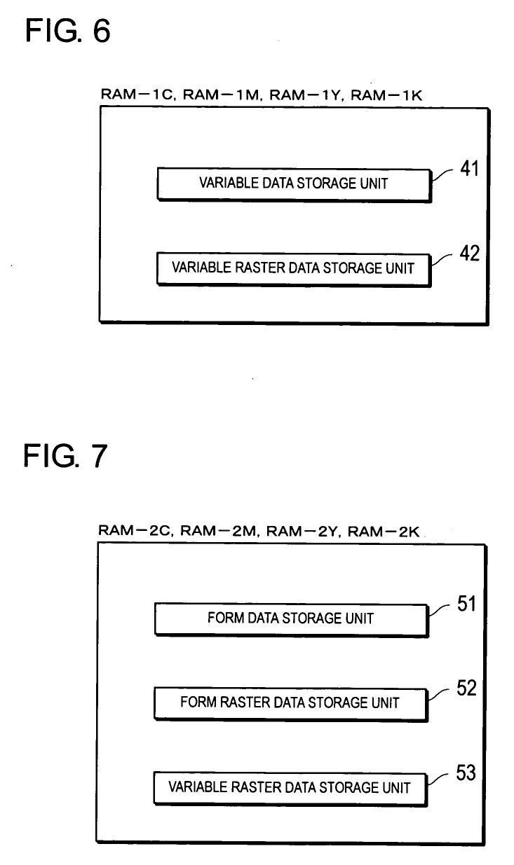

As shown in FIG. 6, RAM-1C, RAM-1M, RAM-1Y, and RAM-1K each have regions for a variable data storage unit 41 and a variable raster data storage unit 42. The variable data storage unit 41 stores the variable data portion of the page data before RIP. The variable raster data storage unit 42 stores the variable raster data, which is the variable data after RIP. Hereinafter, the variable raster data of the C plane is called as “RVC”, the variable raster data of the M plane as “RVM”, the variable raster data of the Y plane as “RVY”, and the variable raster data of the K plane as “RVK”.

As shown in FIG. 7, each of RAM-2C, RAM-2M, RAM-2Y, and RAM-2K has regions for a form data storage unit 51, a form raster data storage unit 52, and a variable raster data storage unit 53. The form data storage unit 51 stores the form data portion of the page data before RIP. The form raster data storage unit 52 stores the form raster data, which is the form data after RIP. Hereinafter, the form raster data of the C plane is called as “RFC”, the form raster data of the M plane as “RFM”, the form raster data of the Y plane as “RFY”, and the form raster data of the K plane as “RFK”. The same variable raster data as the one stored in the variable raster data storage unit 42 is written into the variable raster data storage unit 53.

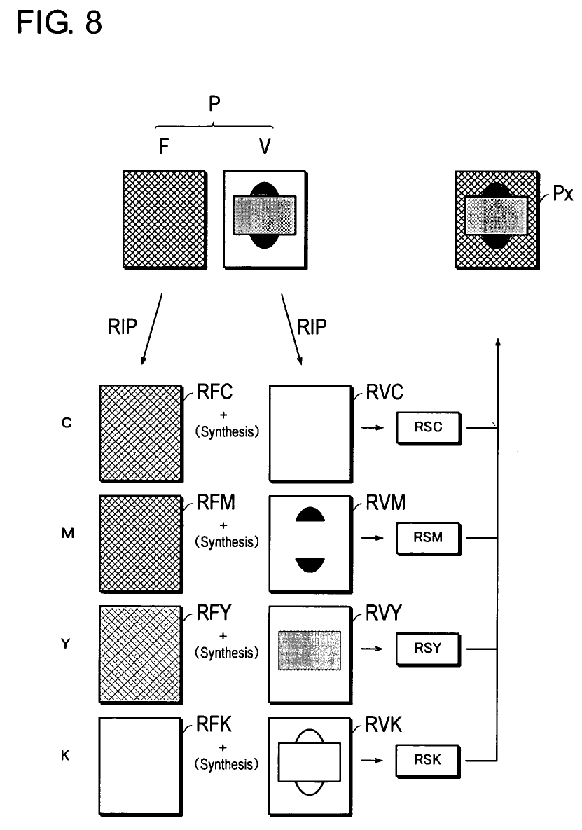

FIG. 8 is a diagram for exemplifying data handled by the present embodiment.

The page data P contained in the printing job consists of the form data F and the variable data V. To make it easier to understand, FIG. 8 shows the page data consisting of one page only. Form raster data RFC, RFM, RFY, and RFK are generated by applying the RIP to the form data F by means of rasterizers RIP-C, RIP-M, RIP-Y, and RIP-K respectively. Similarly, variable raster data RVC, RVM, RVY, and RVK are generated by the rasterizers RIP-C, RIP-M, RIP-Y, and RIP-K applying RIP to the variable data V. The form raster data and the variable data are combined to generate page data for printing RSC, RSM, RSY, and RSK for each color component. The symbol “Px” shown in the diagram denotes print result based on printing page data for each color component.

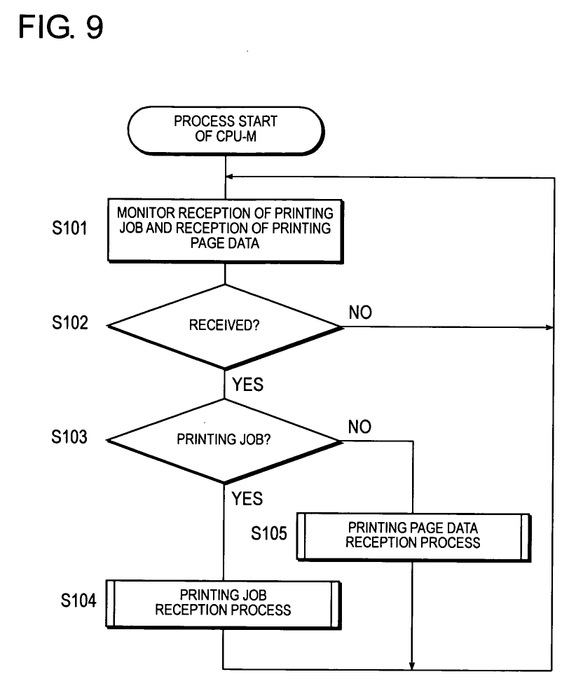

Next, the process executed by the main processor of the printer controller 2 will be described below referring to FIG. 9 through FIG. 11. The algorithm shown in the flowcharts of FIG. 9 through FIG. 11 is stored as a program in the ROM-M of the printer controller 2 and executed by CPU-M.

CPU-M monitors reception of a printing job from the client terminal 1 and reception of printing page data from CPU-2C, CPU-2M, CPU-2Y, and CPU-2K (S101), and stands by until a printing job or printing job page data is received (S102: No).

When a printing job or printing page data is received (S102: Yes), a judgment is made as to whether it is a printing job or not (S103).

If a printing job is received from the client terminal 1 via the network interface 22 (S103: Yes), the printing job reception process is executed (S104). On the other hand, if what is received is not a printing job, and hence a plane of the page data for printing for each color component is received from CPU-2C, CPU-2M, CPU-2Y, or CPU-2K (S103: No), the printing page data reception process is executed (S105).

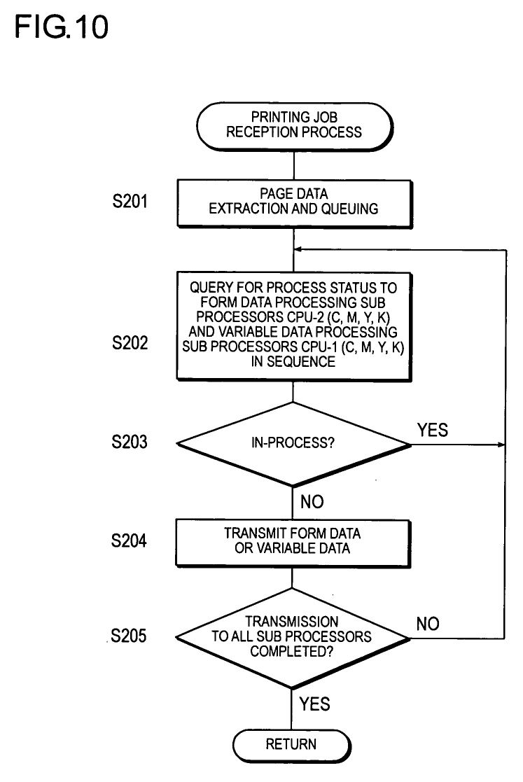

Next, the printing job reception process will be described with reference to FIG. 10.

First, the page data P is extracted from the received printing job and is queued to the page queue 31 (S201). The page data P is managed per page in accordance with the ID information as shown in FIG. 3.

A query is made, in sequence, about processing status to the sub processors for form data CPU-2C, CPU-2M, CPU-2Y, and CPU-2K as well as sub processors for variable data CPU-1C, CPU-1M, CPU-1Y, and CPU-1K (S202). However, no query is made to the sub processors once they have finished transmitting the form data F and the variable data V.

If the processing status of the sub processor to which the query is made, is “not in-process”, in other words, “standby” (S203: No), either the form data F or the variable data V, that is the processing object of the particular sub processor, is transmitted (S204). On the other hand, if the processing status of the sub processor to which the query is made, is “in-process” (S203: Yes), the program returns to the step S202.

In the step S205, a judgment is made as to whether the transmission of the form data F and the variable data V has completed or not, with regard to each of the sub processors for form data CPU-2C, CPU-2M, CPU-2Y, and CPU-2K as well as sub processors for variable data CPU-1C, CPU-1M, CPU-1Y, and CPU-1K.

If the transmission of the form data F and the variable data V to all the sub processors has not been completed (S205: No), the program returns to the step S202. If the transmission of the form data F and the variable data V to all the sub processors has been completed (S205: Yes), the program returns to the flowchart of FIG. 9.

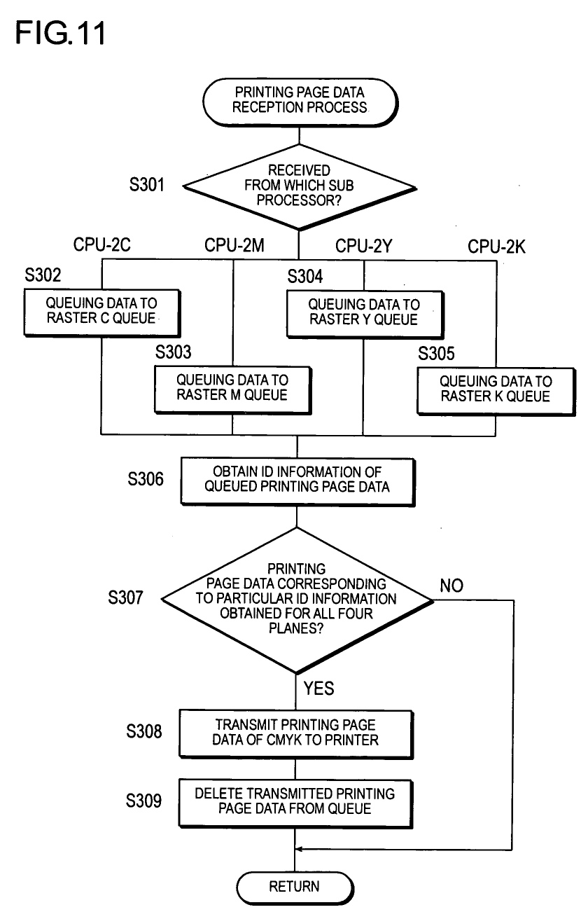

Next, the printing page data reception process will be described with reference to FIG. 11.

First, a judgment is made as to from which of the sub processors the page data for printing has been received (S301).

Based on the judgment, the printing page data RSC received from CPU-2C is queued to the raster C queue 32, the printing page data RSM received from CPU-2M is queued to the raster M queue 33, the printing page data RSY received from CPU-2Y is queued to the raster Y queue 34, and the printing page data RSK received from CPU-2K is queued to the raster K queue 35, respectively (S302-S305). Here, the printing page data RSC, RSM, RSY, and RSK are managed on a page-by-page basis using the ID information that corresponds to the page data P shown in FIG. 3.

Next, the ID information of the queued page data for printing is acquired (S306), and a judgment is made as to whether the page data for printing that corresponds to the acquired ID information contains all the data required for the four planes, C, M, Y, and K (S307). If the printing page data that corresponds to the acquired ID information does not contain all the data required for the four planes (S307: No), the program returns to the flow chart shown in FIG. 9.

On the other hand, if the page data for printing that corresponds to the acquired ID information contains all the data required for the four planes (S307: Yes), the page data for printing for the four planes, i.e., RSC, RSM, RSY, and RSK, are transmitted to the printer 7 via the printer engine interface 23 (S308). The printer 7 prints out the received page data for printing on a printing sheet.

Once the page data for printing, RSC, RSM, RSY, and RSK for C, M, Y, and K, respectively have been transmitted, they are deleted from the raster C queue 32, the raster M queue 33, the raster Y queue 34, and the raster K queue 35, respectively.

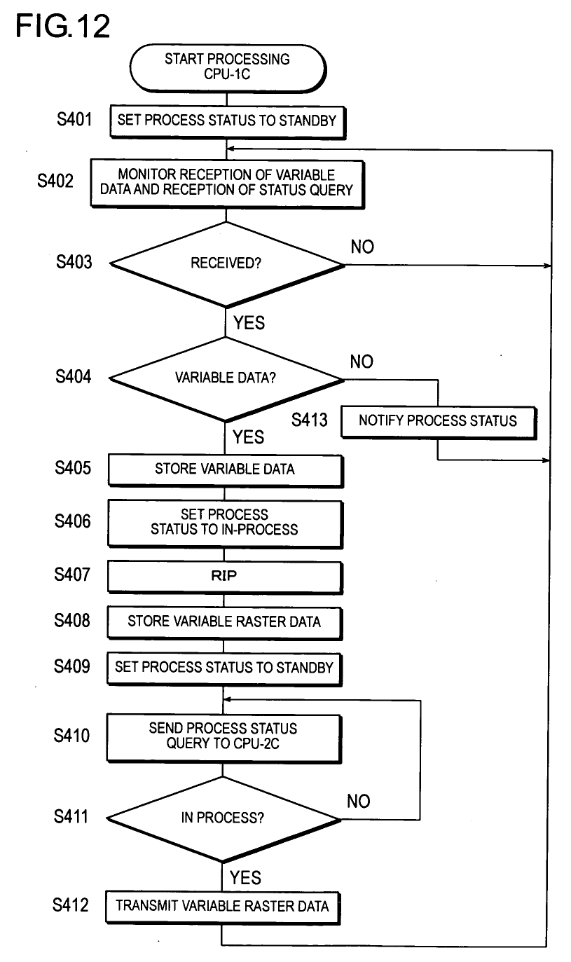

Next, the process executed by the sub processors for variable data of the printer controller 2 will be described below with reference to FIG. 12. Therein, the process executed by CPU-1C, which is one of the sub processors for variable data, will be described. Since the processes executed by the sub processors for variable data are identical except for the color components of the plane to be processed, descriptions of the other sub processors than CPU-1C are not repeated here. The algorithm shown in the flowchart of FIG. 12 is stored as a program in ROM-1C of the RIP and synthesizing unit 21 and executed by the CPU-1C.

First, the CPU-1C sets its processing status to “standby” (S401).

Next, the CPU-1C monitors reception of variable data V and reception of a processing status query (S402), and stands by until receiving a processing status query or variable data V from CPU-M (S403: No).

When a process status query or variable data V is received (S403: Yes), a judgment is made as to whether it is variable data V or not (S404).

If variable data V is received (S404: Yes), the received variable data V is stored into the variable data storage unit 41 page by page (S405), and CPU-1C sets its own processing status to “in-process” (S406).

Next, RIP-C applies RIP to the received variable data V (S407). At this point, RIP-C executes only the process for C (cyan) on the variable data V and outputs only the data for C-plane.

The variable data after RIP is stored as the variable raster data RVC in the variable raster data storage unit 42 (S408), and CPU-1C sets its own processing status to “standby” (S409).

Next, a processing status query is made to CPU-2C, which processes the plane of the same color component (S410).

If the processing status of CPU-2C is “not in-process” (in synthesizing process or RIP of the form data) but, “standby” (S411: No), variable raster data RVC is transmitted to CPU-2C (S412), and the program returns to the step S402. If the processing status of CPU-2C is “in-process” (S411: Yes), the program returns to the step S410.

On the other hand, if it is judged in the step S404 that the received data is not variable data V, but a process status query (S404: No), the current processing status is notified to the CPU-M (S413).

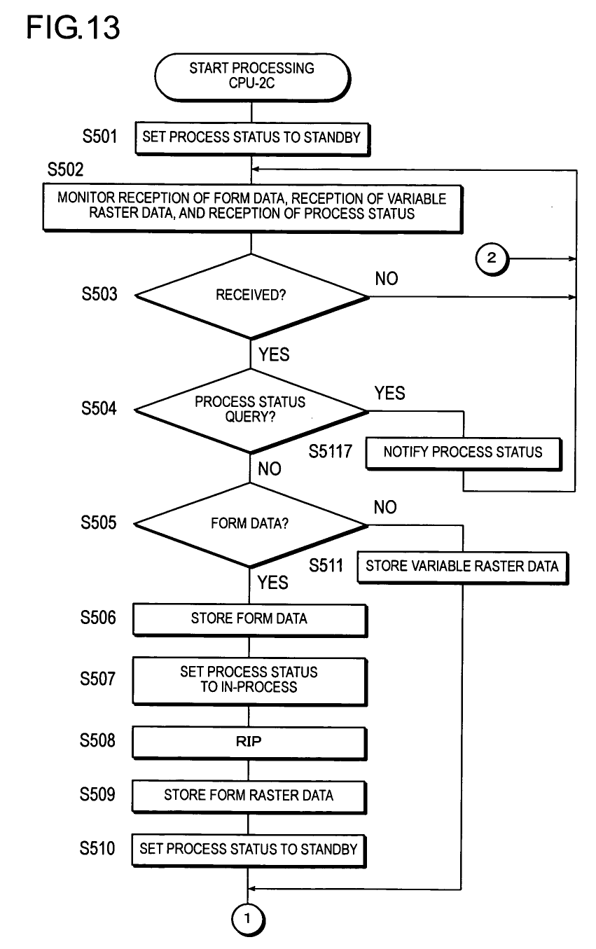

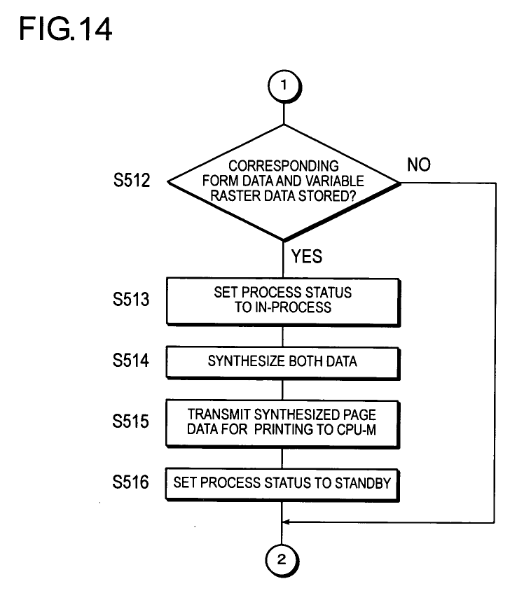

Next, the process executed by the sub processor for form data in the printer controller 2 will be described below with reference to FIG. 13 and FIG. 14. Therein, the process executed by CPU-2C, which is one of the sub processors for form data, will be described. Since the processes executed by the sub processors for form data are identical except for the color of the plane to be processed, their descriptions of the other sub processors for form data than CPU-2C are not repeated here. The algorithm shown in the flowchart of FIG. 13 and FIG. 14 is stored as a program in ROM-2C of the RIP and synthesizing unit 21 and executed by the CPU-2C.

First, the CPU-2C sets its processing status to “standby” (S501).

Next, the CPU-2C monitors reception of form data F, that of variable raster data V, and that of a processing status query (S502), and stands by until receiving form data F, variable raster data RVC, or a processing status query (S503: No).

When form data F, variable raster data RVC, or a processing status query is received (S503: Yes), a judgment is made as to whether it is a processing status query or not (S504). If a process status query is received from CPU-M or CPU-1C (S504: Yes), the current processing status is notified to the source of the query (S517).

If the received message is not a status query (S504: No), a judgment is made as to whether it is form data F (S505).

If form data F is received (S505: Yes), the received form data F is stored into the form data storage unit 51 page by page (S506), and CPU-2C sets its own processing status to “in-process” (S507).

Next, RIP-C applies RIP to the received form data F (S508). At this point, RIP-C executes only the process for C (cyan) on the form data F and outputs only the data for C-plane.

The form data after RIP is stored as the form raster data RFC in the form raster data storage unit 52 (S509), and CPU-2C sets its own processing status to “standby” (S510).

On the other hand, if it is judged in the step S505 that the received message is not form data F, but rather it is variable raster data RVC (S505: No), the variable raster data RVC received from CPU-1C is stored page by page in the variable raster data storage unit 53 (S511).

In the step S512, a judgment is made with reference to FIG. 14 whether or not the form raster data RFC and the relevant variable raster data RVC of the same page have already been stored in the form raster data storage unit 52 and the variable raster data storage unit 53. Here a judgment is made as to whether or not form raster data RFC of the same page is generated when the relevant variable raster data RVC is received from CPU-1. Such a judgment is made on a color-by-color basis.

Both of the form raster data RFC and the relevant variable raster data RVC have already been stored (S512: Yes), CPU-2C sets its own processing status to “in-process” (S513), combine both data to synthesize the printing page data (S514).

The synthesized page data for printing is transmitted to CPU-M (S515). Then, CPU-2C sets its own processing status to “standby”(S516), and returns to the step S502.

In the present embodiment, when a processor checks another processor's processing status and founds it to be “in-process”, the former processor is forced to wait until the on-going process of the latter processor is completed. However, it can also be constituted in such a way that the former processor receives a notice of process completion from the latter processor asynchronously when the latter processor's process is completed. In this case, the former processor can continue its processes that do not require synchronization.

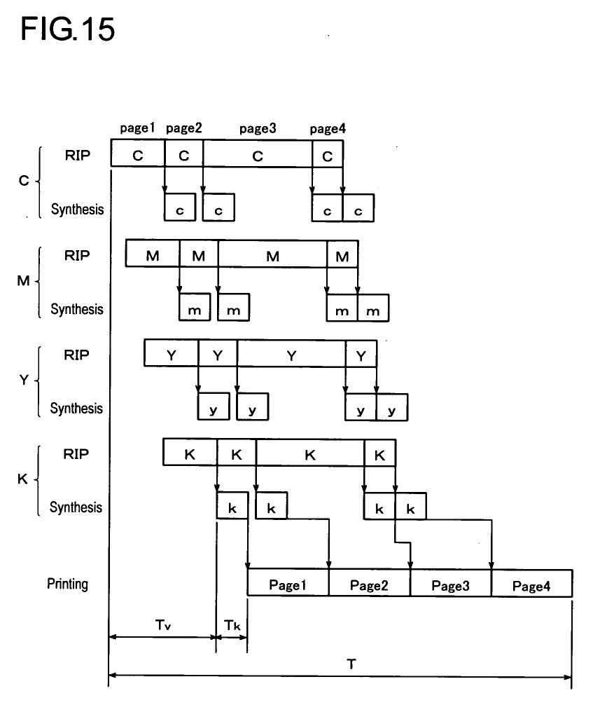

FIG. 15 shows a time chart for the print processing of page data contained in a print job according to the present embodiment.

Here, it is assumed that RIP is applied to the form data in advance. The page data consists of four pages in total, namely, Page 1, Page 2, Page 3, and Page 4. In the diagram, the capital letters “C”, “M”, “Y”, and “K” shown inside rectangular boxes denote RIP processes of variable data for the corresponding color components, while the small letters “c”, “m”, “y”, and “k” shown inside rectangular boxes denote synthesizing processes of the corresponding color components, and Page 1, Page 2, Page 3, and Page 4 shown inside rectangular boxes denote print processing of the corresponding pages.

As shown in FIG. 15, the printer controller 2 of this embodiment applies RIP in parallel to a plurality of the page data each containing variable data and form data corresponding to a color component, and combines the variable raster data, which is the variable data after RIP, and the form raster data, which is the form data after RIP, on a color-by-color basis, in response to the completion of the processing of the variable data (for example, immediately after the completion of the processing).

Thus, as RIP is applied to each of the color components in parallel, the synthesizing process based on the variable raster data and form raster data for one color component is done in parallel with the synthesizing process for the other colors. Thus, the time required for the synthesizing process does not substantially affect the total time (T) for the print processing. In other words, printing of the first page starts after a lapse of RIP completion time (Tv) for completing RIP for all color components of the variable data plus the synthesizing time (Tk) for synthesizing the K plane, as shown in the diagram. Therefore, it is possible to increase the processing speed for printing the page data that contains variable data and form data for each of the plurality of color components.

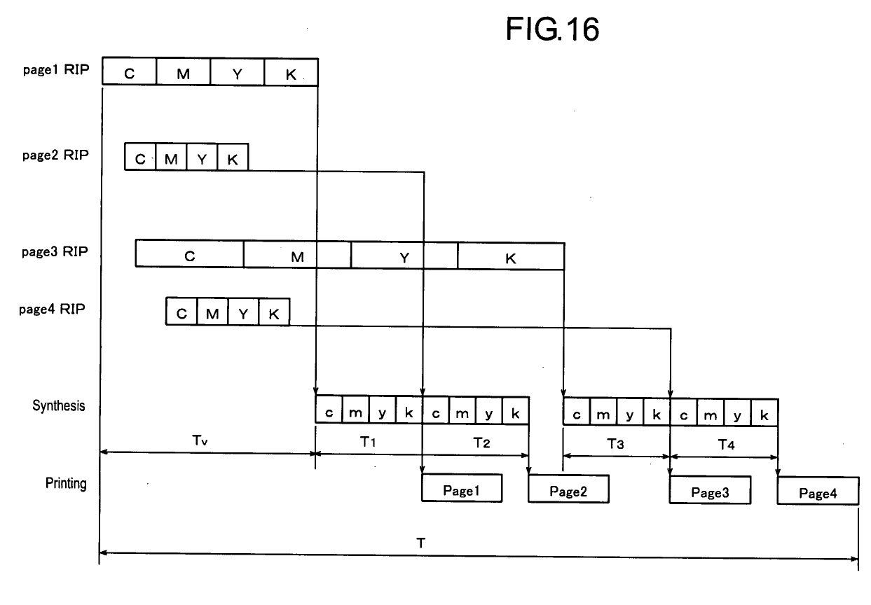

FIG. 16 shows a time chart for the printing process of page data contained in a print job according to a comparative example. In FIG. 16, the RIP time and the synthesizing time for each color component on each page are shown in a similar manner as in FIG. 15.

In this comparative example, RIP is applied, in parallel, to each page data that contains the variable data and form data for each one of the plurality of color components. When RIP to the entire data for one page is completed, the variable raster data, which is the variable data after RIP, and the form raster data, which is the form data after RIP, are combined.

Compared to the embodiment shown in FIG. 15, the RIP completion time (Tv) for completing RIP for all color components of the variable data of the first page becomes longer as RIP for all colors of the variable data is executed by one single sub processor, and the synthesizing time (T1) for synthesizing planes for all color components of the first page becomes longer, as the synthesizing process of the variable raster data and the form raster data for all colors components is executed by the main processor. Therefore, the time required for starting printing the first page (Tv+T1) becomes longer in the comparative example. Also, since the synthesizing time (T1, T2, T3, and T4) for all planes for one page becomes longer for each page, there is a possibility of being unable to print continuously as shown in the diagram and resulting in an interval between adjacent pages. Consequently, the total printing time (T) becomes longer. Such disadvantages compared to the present embodiment become more conspicuous as the number of pages to be printed increases.

As a consequence, the present invention allows not only the image processing being executed in parallel for each one of the plurality of color components, but also the synthesizing process based on a first image data after RIP and a second image data after RIP for one color component being executed in parallel to the synthesizing process of a first image data after RIP and a second image data after RIP for the other color components. Thus, the time required for the synthesizing process does not substantially affect the total time for printing process. Therefore, it is possible to increase the speed of processing page data for printing that contains variable data and fixed data for each one of the plurality of color components.

It is obvious that this invention is not limited to the particular embodiments shown and described above but may be variously changed and modified without departing from the technical concept of this invention.

In the embodiment described above, a mask pattern for each color component is generated and used in combining the variable raster data and the form raster data. However, it is common that the same form data is applied to a plurality of variable data in the variable print. Also, it often happens that a plurality of variable data have the same pattern but contain different images when they are outputted. Therefore, there is a high probability that synthesizing process is performed using a mask pattern with the same configuration for different variable raster data in combining form raster data and variable raster data.

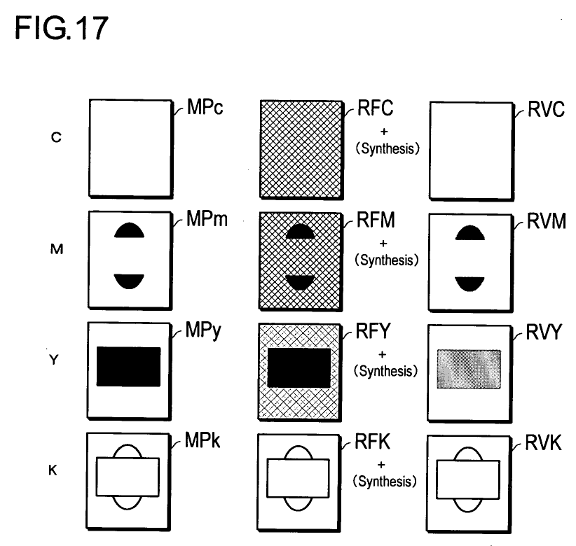

Therefore, it is possible to prepare a mask pattern for the synthesizing process and accompany it with form data F in transmitting the form data F from the main processor CPU-M to the form data processing sub processor. In this case, the form raster data RFC, RFM, RFY, and RFK are mask-processed in advance according to the mask patterns, MPc, MPm, MPy, and MPk respectively as shown in FIG. 17. Therefore, there is no need for mask processing in combining the variable raster data RVC, RVM, RVY, and RVK with the form raster data RFC, RFM, RFY, and RFK. This makes the bit calculation process required for each synthesizing process simpler (due to simple addition) and increases the overall processing speed. Moreover, the sub processor for the form data processing prepares a mask pattern at the time of the first synthesizing process based on the variable raster data and the form raster data, and saves it so that it can use the saved mask patter for the later synthesizing process.

It is also possible to use, in place of a printer, an image forming device such as a facsimile machine, a copying machine, or an MFP (multi-function peripheral) that has a combination of their functions in the above embodiment.

The various processes in the image processing device according to the present invention can be executed by means of a dedicated hardware circuit, or a programmed computer. The program can be provided either by a computer readable recording medium such as a flexible disk and a CD-ROM, and can also be supplied on-line via a network such as the Internet. In this case, the program recorded on the computer readable recording medium is normally transferred to and stored in a memory unit such as a hard disk. The program can also be provided as independent application software, or can be built into the software of the image processing device to function as a part of the software.

What is claimed is:

1. An image forming device, comprising:
a plurality of color component image processing units respectively provided for a plurality of color components and being operable in parallel with each other, each color component image processing unit being for applying image processing to first image data and second image data contained in page data for the respective color component and being for combining the processed first image data and the processed second image data of the respective color component, in response to the completion of the image processing for the respective color component; and
an image forming unit for forming an image based on image data for the plurality of color components processed by the plurality of color component image processing units.

2. An image forming device as claimed in claim 1, wherein
said image processing executed by each of the color component image processing units comprises a rasterizing process for generating image data for the respective color component in a bitmap format.

3. An image forming device as claimed in claim 1, wherein
said first image data is variable data defined in a file containing objects that define at least a portion of the contents of a specific page, while said second image data is fixed data defined in said file and commonly used for a plurality of pages of said file.

4. An image forming device as claimed in claim 1, wherein
said plurality of color components consist of C (cyan), M (magenta), Y (yellow), and K (black).

5. An image processing device, comprising:
an image processing unit that applies image processing to page data containing for each of a plurality of color components first image data and second image data, the image processing for one of the color components being applied in parallel with the image processing for remaining one(s) of the color components; and
a synthesizing unit that combines, for each color component, the processed first image data and the processed second image data, in response to the completion of the image processing to the first image data for the respective color component.

6. An image processing device as claimed in claim 5, further comprising an outputting unit for outputting synthesized data for a particular page when synthesized data for all color components for the particular page obtained by combining the processed first image data and the processed second image data are completed.

7. An image processing device as claimed in claim 5, wherein
the synthesizing unit starts synthesizing process for each color component the processed first image data and the processed second image data, immediately after the image processing of the first image data is completed.

8. An image processing device as claimed in claim 5, wherein
the image processing comprises a rasterizing process for generating image data in a bitmap format.

9. An image processing device as claimed in claim 5, wherein
the first image data is variable data defined in a file containing objects that define at least a portion of the contents of a specific page, while said second image data is fixed data defined in said file and commonly used for a plurality of pages of said file.

10. An image processing device as claimed in claim 5, wherein
the plurality of color components consist of C (cyan), M (magenta), Y (yellow), and K (black).

11. An image processing method comprising the steps of:
1) applying image processing to page data containing for each of a plurality of color components first image data and second image data, the image processing for one of the color components being applied in parallel with the image processing for remaining one(s) of the color components; and
2) combining, for each color component, the processed first image data and the processed second image data, in response to the completion of the image processing of the first image data for the respective color component.

12. A computer readable recording medium stored with an image processing program, said image processing program causing a computer to execute a process comprising the steps of:
1) applying image processing to page data containing for each of a plurality of color components first image data and second image data, the image processing for one of the color components being applied in parallel with the image processing for remaining one(s) of the color components; and
2) combining, for each color component, the processed first image data and the processed second image data, in response to the completion of the image processing to the first image data for the respective color component.
